(19) United States
(12) Patent Application Publication
(10) Pub. No.: US 2022/0317664 A1
(43) Pub. Date: Oct. 6, 2022

(54) EARLY DETECTION OF AND RESPONSE TO FAULTS IN A MACHINE

(71) Applicant: TRUMPF Werkzeugmaschinen SE + Co. KG, Ditzingen (DE)

(72) Inventors: Christian Bauer, Karlsruhe (DE); Daniele Borrelli, Tuebingen (DE); Manuel Kiefer, Sinsheim (DE); Thomas Kieweler, Wimsheim (DE); Martin Lukas, Gerlingen (DE); Jens Ottnad, Karlsruhe (DE); Andrea Schaerer, Gruesch (CH); Martin Schober, Gerlingen (DE)

(21) Appl. No.: 17/844,887

(22) Filed: Jun. 21, 2022

Related U.S. Application Data
(63) Continuation of application No. PCT/EP2020/087174, filed on Dec. 18, 2020.

(30) Foreign Application Priority Data
Dec. 20, 2019 (DE) 10 2019 135 483.8

(51) Int. Cl. G05B 19/418; G05B 19/406; G05B 19/408

(52) U.S. Cl. CPC G05B 19/4184; G05B 19/406; G05B 19/408; G05B 2219/37532

(57) ABSTRACT

A system for the early detection of and response to faults in a machine includes a machine having at least one furst capture device for capturing first signals inside the machine and a first data transmission interface for the broadband transmission of the captured signals inside the machine, at least one second capture device disposed outside the machine for capturing at least one second signal outside the machine, wherein the second capture device has a second data transmission interface for the broadband transmission of the at least one second signal, a data processing system having a broadband data transmission interface, a broadband data transmission channel for transmitting signals between the data transmission interfaces, wherein the data processing system is configured to detect faults using the signals inside the machine and outside the machine based on a common time base and to directly act on the machine.

### CROSS REFERENCE TO RELATED APPLICATIONS

This application is a continuation of International Application No. PCT/EP2020/087174 (WO 2021/123274 A1), filed on Dec. 18, 2020, and claims benefit to German Patent Application No. DE 10 2019 135 483.8, filed on Dec. 20, 2019. The aforementioned applications are hereby incorporated by reference herein.

### FIELD

The invention relates to a method and a system for the early detection of and response to faults in a machine.

### BACKGROUND

It has hitherto not been possible to monitor machines in real time during productive operation since the required volume of data is too large for data streaming and the necessary computing power for processing the volume of data is not available. External observer signals and sensor and process signals inside the machine are needed for a precise diagnostic function.

### SUMMARY

In an embodiment, the present disclosure provides a method for the early detection of and response to faults in a machine that includes the steps of capturing first signals inside the machine and second signals outside the machine, transmitting the captured first and second signals to a data processing system using broadband transmission, detecting a fault by the data processing system using the transmitted first and second signals based on a common time base, and directly intervening by the data processing system in the machine when the fault is detected.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a first embodiment of a system according to the invention;

FIG. 2 shows a second embodiment of a system according to the invention; and

FIG. 3 shows a flowchart for explaining the method according to the invention.

### DETAILED DESCRIPTION

The object of the present invention is to provide a method and a system which make it possible to monitor a machine in real time, such that it is possible to detect faults in good time and to react to them.

This object is achieved, according to the invention, by means of a method for the early detection of and response to faults in a machine, having the following method steps:
a) capture of signals inside the machine and signals outside the machine,
b) broadband transmission of the captured signals to a data processing system,
c) fault detection by the data processing system using the transmitted signals on the basis of a common time base,
d) direct intervention by the data processing system in the machine if a fault is detected and/or a fault message is output by the data processing system.

The monitored machine may be a machine tool, for example. In particular, it may be a machine in productive operation.

The signals inside the machine may be sensor signals and/or process signals. Sensor signals inside the machine may be, for example, current, speed, actual and/or target position values. Process signals may be, for example, laser power, gas pressure, scattered light, etc. Furthermore, the signals inside the machine may come from controllers, for example from a programmable logic controller (PLC) or a numerical controller (NC). They may also come from drives.

Signals outside the machine may be, for example, acoustic, optical or motion signals. They may come from microphones, micro-electromechanical system (MEMS) sensors, cameras, etc.

Measurement and process variables are captured. They represent data. The measurement and process variables are transmitted as signals. Following transmission, the data contained in the signals are processed. Signal transmission and data transmission are used synonymously below.

Broadband data transmission is understood as meaning, in particular, transmission at more than 30 Mbit/s. The broadband transmission may be carried out in a wired manner, for example via a fiber optic cable, or in a wireless manner, for example according to the 5G standard.

The data processing system may be scalable. In particular, the data processing system may be in the form of a processing platform. A processing platform may be a composite system containing components for processing data streams and batch processes (file-based) and components for distributed data processing and data storage. The processing platform may be suitable and configured to receive various forms of data, whether a stream or a file, to then process (analyze) said data (in a distributed manner), suitably manage and store them and, if appropriate, to also suitably visualize them. Furthermore, the data processing system may be in the form of a high-performance computer in a cloud environment. This may be an external, remote and/or Internet-based, cloud or an in-house cloud. A cloud is understood as meaning, in particular, a computing center with a broadband network connection, a high computing power and a mass memory. The cloud may comprise programs and hardware in the form of servers. In an external cloud, data from a plurality of different businesses, including non-associated businesses, can also be anonymized, collected and correlated. This may further improve the fault detection result.

On the basis of the fault detection, the data processing system may directly intervene in the machine. This makes it possible to ensure the highest machining quality. The machine may also be protected from destruction. It is also conceivable to output only an indication, in particular a fault message, to an operator who can then intervene in the machine.

The broadband high-speed data transmission or high-speed signal transmission makes it possible to port the data, virtually in real time, to in particular scalable high-performance computers, in cloud environments, where correlating data valuations can be carried out for the early detection of faults. This functionality may be used as an early warning system for machine tools and other systems. An online diagnostic functionality may be provided on the basis of a common time base of all available measurement and process variables. Early fault detection during ongoing operation and possible intervention in the machining process may therefore be carried out as a result of immediate data processing. Raw data streaming is possible on account of the provision of broadband data transmission. The computing-intensive signal processing, for example with the inclusion of AI-based approaches, may be carried out completely in scalable computing clusters.

The signals may be at least partially synchronized before transmission. For example, the signals can be recorded in a time-synchronous manner inside the system in question by providing exactly synchronous reference clocks.

An online diagnostic functionality means immediate data processing in order to be able to provide the user with indications in good time if discrepancies are detected so that the user can intervene in the ongoing process if necessary, for example in the event of vibrations in the workpiece to be machined or in the case of burr formation. Automatic, controlled intervention in the machining process is likewise conceivable. This may be carried out online and virtually in real time.

The signals may be at least partially synchronized after transmission. The subsequent synchronization can be carried out in the cloud, for example on the basis of known signal patterns. Mixed forms are conceivable. Individual signals may therefore be captured in sync with one another in terms of time or may be synchronized before transmission and further signals may be synchronized only in a later process after transmission.

It is also conceivable that signal groups are formed, the signals within a signal group being synchronized. The signals in one signal group can then be synchronized with signals in another signal group or with other individual signals.

At least some signals can be captured with a different time resolution. The synchronization can be carried out before or after data transmission. Signals with a different time resolution may also be synchronized with one another.

The fault detection can be carried out on the basis of population comparisons. Signal patterns and/or fault images may be previously determined and/or stored for this purpose. Fault indicators (also markers, etc.) which are applied to all of the previously available (measurement) data (both data from the machine series and data from the machine history of the individual machine) can be determined from the signal patterns and/or fault images. Fault detection and possibly even fault selection are then possible on this basis. It is consequently also possible to identify faults with sufficiently available domain knowledge. Domain knowledge globally describes the relationship of vibration excitation by machine components, axis dynamics, absolute position of the kinematic chain, possibly on the basis of the working area, actuators, for example valves, the operating state of a machining unit and noise emissions (sound waves).

A laser, a punching apparatus, a press, a milling head, saw, a drill and a water jet are possible, for example, as the machining unit. In machine tools, the machining units are moved in a particular axial direction via drives and possibly mechanical components connected in between, such as gears or gantries. This is often referred to in short form as an axis. All components, in particular axes, which contribute to a movement of a machining unit are called a kinematic chain. Furthermore, the domain knowledge includes the relationship between individual components, in particular the infrastructure, movement trajectories, machining processes and properties of all components involved.

It is also possible to store data models which are used to detect faults. Population comparisons may be carried out on the basis of measurement data from structurally identical machines (machine series) or the machine itself (historical measurement data recording) in identical or similar operating states. The measurement data may be continuously captured, assessed in an expert-based and self-learning manner and stored in data models.

In this case, the fault detection may be recursively carried out on time series of the individual object. Historical data from the same machines may also be used for this purpose. It is possible to carry out a comparison with identical and comparable operating states which have already been recorded.

In the case of physically/technically slowly changing variables, for example the temperature, measured value capture can be supplemented by means of interpolation.

In the case of adequate system knowledge in particular, the data rate, resolution and/or quantification of individual signals can be adaptively adapted (up-sampling/down-sampling). This makes it possible to ensure that a sufficient database is provided for the evaluation.

The scope of the invention also includes a system for the early detection of and response to faults in a machine, having
a) a machine, in particular a machine tool, wherein the machine has capture devices for capturing signals inside the machine,
b) at least one capture device outside the machine for capturing at least one signal outside the machine,
c) a data processing system,
d) a broadband data transmission channel for transmitting signals,
e) wherein the data processing system is configured to detect faults using the signals inside the machine and outside the machine on the basis of a common time base and to directly act on the machine and/or to output a fault message.

The machine may have a data transmission interface for the broadband transmission of the captured signals. In particular, the signals inside the machine may be transmitted via the data transmission interface. If the capture devices outside the machine are not completely independent, the signals outside the machine may also be transmitted via the data transmission interface of the machine. In particular, a machine controller may be configured for broadband data transmission.

The at least one external capture device may have a data transmission interface for the broadband transmission of the captured signal outside the machine.

The data processing system may have a broadband data transmission interface.

The broadband data transmission channel may transmit data between the machine and/or the at least one capture device outside the machine and the data processing system. In particular, the broadband data transmission channel may transmit data between the data transmission interfaces.

The system according to the invention, in particular the data processing system, may be scalable. The scalable data processing system may be in the form of a processing platform. The data processing system is configured, in particular, for immediate data processing in order to be able to provide indications in good time if discrepancies or faults are detected and/or to be able to intervene in the machining process of the machine in an automatically controlled manner. The fault detection may take place on the basis of population comparisons or recursively on time series of the individual object on the basis of statistical variables, pattern recognition, time series, calculated variables, etc. Patterns, fault images or data models may be determined and provided for the population comparisons. The data processing system is configured to process the corresponding volume of data and to execute the algorithms required for diagnosis.

A central capture and data transmission unit may be provided. This may be, for example, in the form of a real-time capable data capture unit having at least one physical communication interface and, in particular, having a data storage functionality. The central capture and data transmission unit may combine and synchronize both external and internal signals and may transmit the data in a collected form. In the case of a large number of signal sources, a plurality of such capture and data transmission units may be provided and the data may be combined and/or synchronized in the data processing system in the cloud. It is possible to transmit signals in a bidirectional manner. One broadband transmission channel or a plurality of broadband transmission channels may be provided. A central capture and data transmission unit may be both a transmitter and a receiver and may directly communicate with machine controllers and machine drives and may thus directly influence processes which are carried out by the machine.

A synchronization device for synchronizing signals may be provided on the data processing system side and/or machine side. Signals may be captured with a different time resolution, but time synchronization is required before data transmission (requires time-synchronous signal recording within the system in question by ensuring exactly synchronous clocks) or after data transmission. Mixed forms may also be provided, with the result that individual signals are in sync with one another in terms of time before transmission and further signals are synchronized only in a subsequent process for time synchronization after transmission. It is also conceivable to form clusters. There may be a plurality of signal groups within which individual signals are in sync with one another in terms of time.

The data processing system may be implemented in a cloud environment. This may be an Internet cloud or an on-premise edge cloud (decentralized data processing at the edge of a compound structure).

As already mentioned above, a signal cluster having a plurality of time-synchronous signals may be provided.

A machine controller may be provided, on which the data processing system acts. In this case, the data processing system may act directly on the machine controller or via a capture and data transmission unit mentioned above. It is likewise conceivable to act on a plurality of machine controllers.

A memory for storing signal patterns, fault images and/or data models, which is connected to the data processing system, may be provided. A comparison with the captured and transmitted data may be carried out on the basis of the stored data. This makes it possible to detect faults in real time.

The captured signals are sampled at high frequency if possible and, in the case of analog signals, are resolved/quantized as finely as possible. With adequate system knowledge, adaptive adaptation (both reduction and increase) of the data rate and resolution of individual signals is conceivable. This adaptation may be dependent on the current or future planned operating state.

Further features and advantages of the invention are evident from the following detailed description of exemplary embodiments of the invention, with reference to the figures of the drawing, which shows details essential to the invention, and from the claims. The features shown there should be understood as being not necessarily to scale and are illustrated in such a way that the special features according to the invention can be made visible. The various features can be realized in each case individually by themselves or as a plurality in any desired combinations in variants of the invention.

The schematic drawing illustrates exemplary embodiments of the invention and these are explained in more detail in the description which follows.

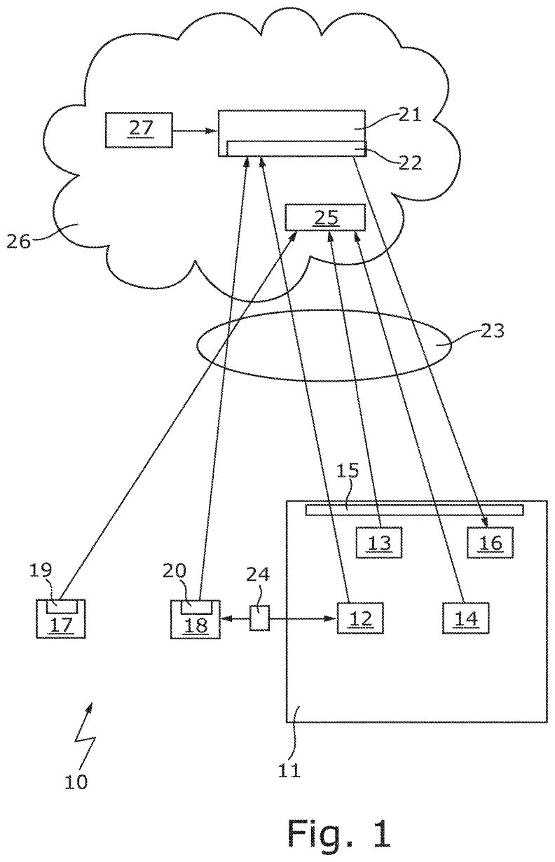

FIG. 1 shows a first embodiment of a system 10 for the early detection of and response to faults in a machine 11. The machine 11 may be in the form of a machine tool, for example. The machine 11 has capture devices 12, 13, 14 for capturing signals inside the machine. The capture devices 12 to 14 may be sensors and/or controllers and/or drives of the machine 11. The signals from the capture devices 12 to 14 may be transmitted via a data transmission interface 15 which is designed for the broadband transmission of the captured signals inside the machine.

The system 10 also has capture devices 17, 18 outside the machine for capturing signals outside the machine. The capture devices 17, 18 may be microphones or cameras, for example. The external capture devices 17, 18 may each have a data transmission interface 19, 20 for the broadband transmission of the captured signal outside the machine.

The captured signals may be transmitted to a data processing system 21 via a broadband transmission channel 23, wherein the data processing system 21 likewise has a broadband data transmission interface 22. The data processing system 21 is configured to detect faults using the signals inside the machine and outside the machine on the basis of a common time base and can directly act on the machine 11, in particular a machine controller 16.

So that the data can be processed and evaluated by the data processing system 21, they must have a common time base. In order to synchronize the captured signals, a synchronization device 24 on the machine side may be provided, on the one hand. On the other hand, a synchronization device 25, which may have a data transmission interface that is not illustrated, may be provided on the data processing system side. In this case, it is also conceivable for some signals to be synchronized on the machine side and for other signals to be synchronized on the data processing system side. A memory 27 can store, for example, signal patterns, fault images and/or data models, on the basis of which the data processing system 21 can carry out data processing and analysis as well as fault detection. The data processing system 21 is implemented in a cloud environment 26.

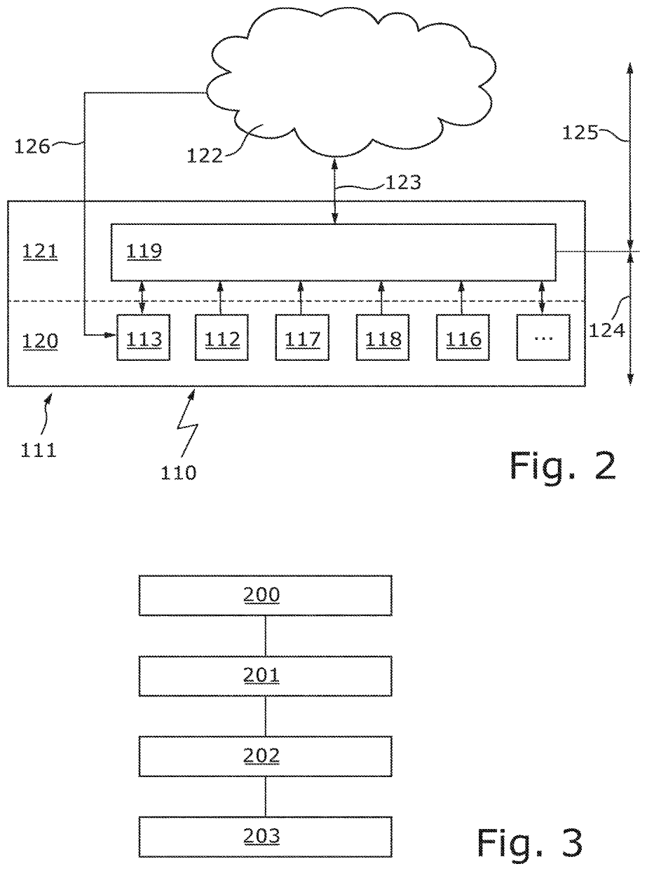

FIG. 2 shows an alternative embodiment of a system 110 according to the invention. Capture devices 112, 113, 116 to 118 are provided on the machine 111, wherein the capture devices 112, 113, 116 may be inside the machine, whereas the capture devices 117, 118 may be outside the machine. The capture devices 117, 118 may be a microphone and a camera, for example. If the capture devices 117, 118 are completely independent, they need their own (broadband) data transmission interface. Otherwise, their data may be captured via a capture and data transmission unit 119, possibly aggregated and then transmitted. The capture device 112 may be in the form of a MEMS sensor, for example. The capture devices 113, 116 may be machine controllers.

The capture devices 112, 113, 116 to 118 communicate with the central capture and data transmission unit 119 which may be in the form of a sensor box (network). In particular, it may be in the form of a real-time capable external data capture unit having at least one physical communication interface and, in particular, a data storage functionality. The capture and data transmission unit 119 has an interface for broadband signal transmission. This interface may constitute the broadband data transmission interface of the machine 111.

On the machine side, a subdivision into a sensor/actuator level 120 and a communication level 121 may be provided, wherein data collection and preprocessing can be carried out on the latter.

The central capture and transmission unit 119 may communicate with a cloud-based data processing system 122 via a broadband data transmission channel 123. For this purpose, the data processing system 122 has a broadband data transmission interface. In the data processing system 122, the transmitted signals and data can be analyzed and processed on the basis of predefined algorithms, population diagnosis, domain knowledge, etc. In particular, faults can be detected in this manner.

The data transmission channel 123 may be bidirectional, with the result that it is possible to directly act on the machine 111 via the data processing system 122. In particular, data can be transferred to the central capture and data transmission unit 119 and, from the latter, transferred to the controllers 113, 116 for this purpose. This makes it possible to directly intervene in the machine 111. Alternatively or additionally, it is conceivable for a further data transmission channel 126 to be provided, via which it is possible to directly intervene in a controller 113.

So that a data analysis can be carried out, a common time base must be provided. This is indicated by the regions 124, 125 marked with arrows. Hard real-time synchronization can be carried out in the region 124. In particular, signals can be captured in a time-synchronous manner. Hard real-time synchronization is not absolutely necessary in the region 125, but time information relating to the signals is necessary so that temporal synchronization can be carried out after data transmission.

If a laser cutting process, for example, is carried out on the machine 111, the cutting process can be aborted after the next contour to be cut if a fault is detected. Alternatively, a defined abort can be effected on a cutting contour. It is also conceivable for the data processing system 122 to actively intervene in the axis control of the machine 11 or to adapt the parameters for the laser machining process.

FIG. 3 shows a flowchart for illustrating the method according to the invention. In method step 200, signals inside the machine and signals outside the machine are captured.

In step 201, broadband transmission of the captured signals to a data processing system is carried out. In step 202, faults are detected by the data processing system using the transmitted signals on the basis of a common time base.

In step 203, the data processing system directly intervenes in the machine if a fault is detected, or a fault message is output.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for the early detection of and response to faults in a machine, the method comprising:
a. capturing first signals inside the machine and second signals outside the machine;
b. transmitting the first and second captured signals to a data processing system using broadband transmission;
c. detecting a fault by the data processing system using the transmitted first and second signals based on a common time base
d. directly intervening by the data processing system in the machine when the fault is detected.

2. The method as claimed in claim 1, further comprising at least partially synchronizing the first and second signals before the transmitting.

3. The method as claimed in claim 1, further comprising at least partially synchronizing the first and second signals after the transmitting.

4. The method as claimed in claim 1, further comprising forming at least one signal group, wherein the signals within the signal group are synchronized.

5. The method as claimed in claim 1, further comprising capturing at least some of the first and second signals with a different time resolution.

6. The method as claimed in claim 1, wherein the fault detection is carried out on the basis of population comparisons.

7. The method as claimed in claim 1, wherein the fault detection is carried out recursively on time series of the individual object.

8. The method as claimed in claim 1, wherein at least one captured signal is supplemented by means of interpolation.

9. The method as claimed in claim 1, further comprising adaptively adapting at least one of a data rate, a resolution and a quantification of the first and second signals.

10. A system for the early detection of and response to faults in a machine, the system comprising:
a. a machine having at least one first capture device for capturing first signals inside the machine,
b. at least one second capture device disposed outside the machine for capturing at least one second signal outside the machine,
c. a data processing system,
d. a broadband data transmission channel for transmitting signals,
e. wherein the data processing system is configured to detect faults using the first signals inside the machine and the second signal outside the machine based on a common time base and to directly act on the machine.

11. The system as claimed in claim 10, further comprising a synchronization device for synchronizing signals disposed on a data processing system side and/or a machine side.

12. The system as claimed in claim 10, wherein the data processing system is scalable.

13. The system as claimed in claim 10, wherein the data processing system is implemented in a cloud environment.

14. The system as claimed in claim 10, further comprising a signal cluster having a plurality of time-synchronous signals.

15. The system as claimed in claim 10, further comprising a machine controller, wherein the data processing system acts on the machine controller.

16. The system as claimed in claim 10, further comprising a memory for storing at least one of signal patterns, fault images and/or data models, wherein the memory is connected to the data processing system.
